(19) United States
(12) Patent Application Publication
(10) Pub. No.: US 2012/0066683 A1
(43) Pub. Date: Mar. 15, 2012

(54) BALANCED THREAD CREATION AND TASK ALLOCATION

(76) Inventor: Nadig S. SRINATH, Bangalore (IN)

(21) Appl. No.: 12/942,028

(22) Filed: Nov. 9, 2010

(30) Foreign Application Priority Data
Sep. 9, 2010 (IN) 2635/CHE/2010

(51) Int. Cl. G06F 9/46

(52) U.S. Cl. 718/102

(57) ABSTRACT

Methods for balancing thread creation and task scheduling are provided for predictable tasks. A list of tasks is sorted according to a predicted completion time for each task. Then tasks are assigned to threads in order of total predicted completion time, and the threads are scheduled to execute the tasks assigned to the threads on a processor.

### BACKGROUND

A software program is designed to perform a set of tasks. Multi-threaded architecture is a popular approach for highly concurrent applications. If the tasks can be divided into a set of independent sub-tasks or jobs, multiple threads could be employed to effectively perform the tasks, maximizing the resource usage.

Typically, in multi-threaded applications, tasks are assigned in sequential order. That is, if there is a set of tasks to be allocated to a certain number of threads, tasks are scheduled to threads without considering any task characteristics, such as expected task completion time, availability of thread, dynamic environmental deviations or the like. This sequential task assignment to threads can result in under- or over-utilization among individual threads, as tasks get completed randomly, affecting the overall application response time.

User level multi-threaded applications rely on operating system provided scheduling processes and capabilities. Due to operating system and system resource constraints, there is a limitation on the number of threads a process can create for parallelism of activities. For applications with high scalability and availability requirements, this brings in a need for effectively utilizing the resources and scheduling the activities on available threads.

There are several techniques available for recording and predicting the tasks completion time pattern based on previous attempts like Simple, Cumulative, Exponential, or Weighted Moving Averages. To schedule these sub-tasks, Shortest Job First (SJF), Longest Job First (LJF), First-Come, First-Served (FCFS), or Fixed priority pre-emptive scheduling disciplines could be used, for example. By closely analyzing the effective per thread throughput and the total task run times, a high deviation and ineffective per thread usage pattern can be found/observed.

An example of such an application is a data server, which acquires and maintains a set of connections to databases or distributed resources, servicing requests for data queries. In such systems, if there are no free threads available immediately to service the incoming requests, requests gets queued up sequentially. Once the threads complete the running tasks, the scheduler schedules the next tasks in the queue without considering any task characteristics. Subsequent requests in the queue have to wait for others to complete even though a waiting task might comparatively require a small amount of time to complete. This increases the overall system response time. Further external influences like external supporting systems, for example a bad network in case of an application depending on distributed resources, might result in relinquishing (losing) the acquired resources. This puts in a requirement of acquiring all the resources as fast as possible during startup, and to subsequently reacquire lost resources quickly and efficiently.

For the above reasons, and for other reasons stated below which will become apparent to those skilled in the art upon reading and understanding the present specification, there is a need in the art for effectively scheduling tasks in multi-threaded applications to allow the threads to work and complete together.

### BRIEF DESCRIPTION OF DRAWINGS

FIG. 1 is a flow chart diagram of a method according to one embodiment of the present disclosure;

FIG. 2 is a flow chart diagram of a method according to another embodiment of the present disclosure;

FIG. 3 is a flow chart diagram of a method according to another embodiment of the present disclosure; and

FIG. 4 is a flow chart diagram of a method according to another embodiment of the present disclosure.

FIG. 5 is a flow chart diagram of a method according to another embodiment of the present disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in detail to enable those skilled in the art to practice the subject matter of the disclosure and it is to be understood that other embodiments may be utilized and that process or mechanical changes may be made without departing from the scope of the present disclosure. The following detailed description is, therefore, not to be taken in a limiting sense, and the scope of the present disclosure is defined by the appended claims and equivalents thereof. In this specification, the terms task and activity are used interchangeably referring to one another.

The various embodiments of the present disclosure include techniques for effectively scheduling tasks on threads, for example to reduce the total task completion time along with high per thread usage throughput. The scheduling disclosed herein can be applied repeatedly to handle situations where actual completion time differs with a predicted completion time.

The various embodiments include methods of balancing allocation of tasks to threads, and determining a number of threads for a given list of tasks. The embodiments further reallocate tasks when a deviation in task completion, such as early completion or delayed/stalled completion or system timeout occurs. Embodiments of methods for allocating tasks among threads include ordering the tasks by a predicted time they will take to complete, and assigning tasks to threads based in descending order of the expected time to complete. In some embodiments of task assignment, a total expected time to complete is maintained for each thread, and the next task is assigned to the thread with the lowest expected time to complete, until all tasks are assigned to threads. In other embodiments, dynamic reallocation of tasks is accomplished when a deviation in task completion time occurs.

Table 1 shows an example of a list of tasks (R1 . . . R10) each having a past connection time, which is referred to herein as a predicted completion time. The table is used for explanatory purposes, and is not meant to represent actual data. Table 1 refers to an application which is to connect ten servers for acquiring resources. During an initial phase or the first time the application starts, it can assume equal time for all and subsequently start recording the values.

The predicted completion time of previous attempts can be averaged over the past few attempts, for example, the past five completion times, or the predicted completion time can be the completion time of the previous successful attempts, or the like. This is presumed to already have been done for the values shown in Table 1, that is, the values are predicted completion time for the tasks based on historic or other measured completion times for the various tasks.

TABLE 1

| Resource ID | Past Connection Time (ms) |
|---|---|
| R1 | 100 |
| R2 | 50 |
| R3 | 30 |
| R4 | 420 |
| R5 | 320 |
| R6 | 200 |
| R7 | 70 |
| R8 | 228 |
| R9 | 328 |
| R10 | 8 |

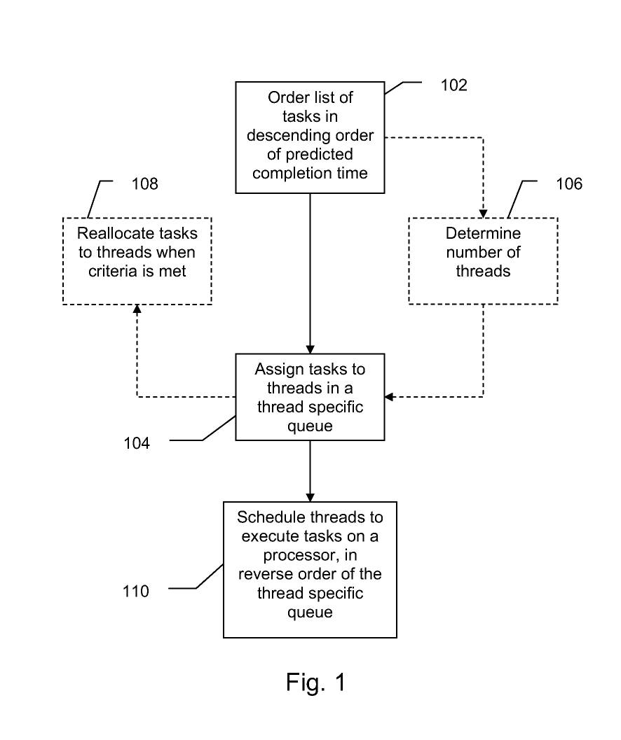

For a method describing the assignment of tasks to threads, reference is made to FIG. 1, which is a flow chart diagram of a method 100 for balancing thread creation and allocation in assigning tasks to threads. Method 100 comprises sorting the list of predicted completion times for the tasks of the list in descending order in block 102, and assigning the ordered tasks to threads and into a thread specific queue in block 104. Once the tasks are assigned to threads, the threads are scheduled to execute the tasks, in reverse order of the thread specific queue, as shown in block 110, on a processor. In one example, after the completion of assigning the tasks to the plurality of threads, operation of each thread is started with the task having the lowest predicted connection time, and thereafter with the next lowest predicted connection time, etc.

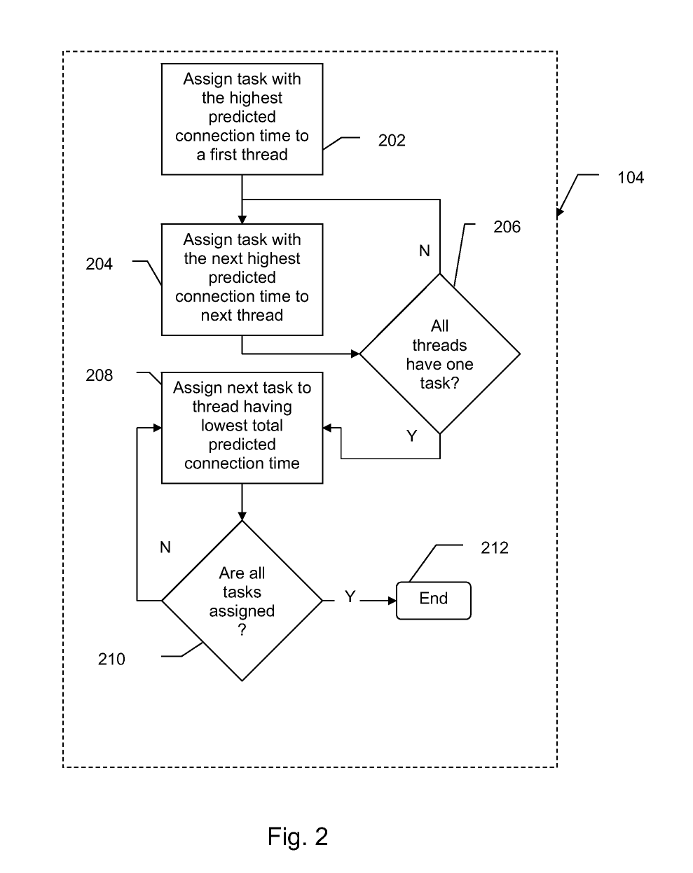

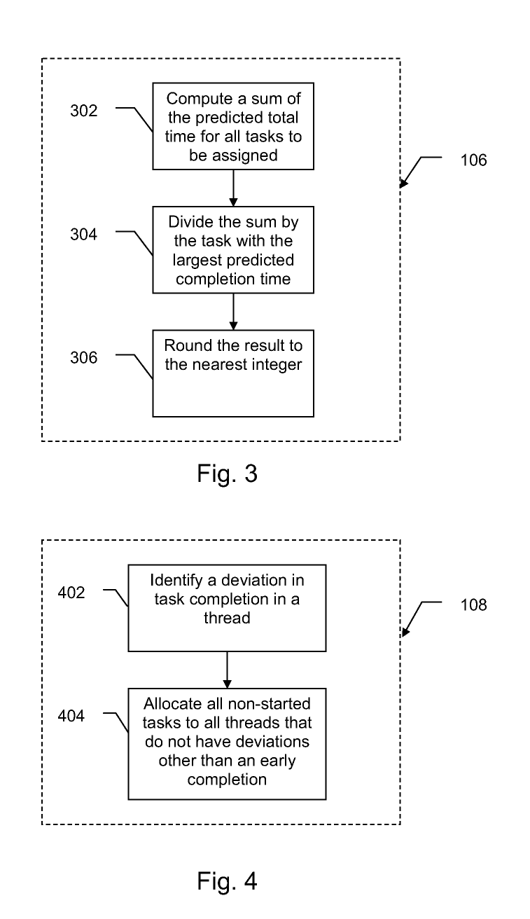

The method of block 104 for assignment of the ordered tasks to threads is shown in detail in FIG. 2. The tasks R1 . . . R10 are to be assigned in the present example to four threads. It should be understood that the number of threads may be computed (as described below with respect to FIG. 3), may be assigned, may be based on the number of threads available, or the like. The embodiments described herein can be applied, equally well no matter what the number of threads, or how the number of threads to be used is determined.

Assigning tasks as in block 104 is shown in detail in FIG. 2. Block 104 assigns the task with the highest predicted connection time to a first thread in block 202, assigning the task with the next highest predicted connection time to the next thread in block 204, and repeating, as determined by decision block 206, until each thread has one assigned task. In block 208, the next task is assigned to the thread having the lowest total predicted connection time, the lowest total predicted connection time determined in one example by summing the predicted connection times for all tasks assigned to that thread. This is repeated, until, as determined in decision block 210, all tasks are assigned, in descending order of predicted connection time, to the respective thread that currently has the lowest total predicted connection time for all tasks assigned to that thread (i.e., the least loaded thread), at which point the process flows ends at block 212.

In another sub-part of the method 100, a number of threads to be used to complete the tasks in list, can be determined as in block 106. Block 106 is shown in detail in FIG. 3, described below. In another sub-part of the method 100, tasks are reallocated among threads in block 108 when a criteria is met, for instance, a rebalancing of threads is triggered to account for changing conditions and delays or stalls in task completion against the predicted completion task time, or when a deviation in task completion time from the predicted completion time is detected. Block 108 is shown in detail in FIG. 4, described below.

Determining a number of threads to complete a set of tasks, as in block 106, is shown in detail in FIG. 3. For one solution, a time for completion of tasks in a plurality of tasks for a thread is a time equal to the predicted completion time of the longest task in the plurality of tasks, Tpmax. Considering this as a desired life time of each of the other threads, a number of threads, Tn, for completing the other tasks, can be determined. Block 106 comprises in one example computing the sum of the predicted total time for all tasks to be assigned in block 302, dividing the sum by the task with the largest predicted completion time in block 304, and rounding the result to the nearest integer in block 306, the rounded result being the number of threads.

This method has certain limitations, as it depends on a predicted completion time statistical distribution. For example, consider computation of a number of threads for a sample data set, R[10]={10, 10, 10, 9, 10, 9, 9, 10, 10, 9} with N=10, which results in SUM/Tpmax=96/10=9.6 and rounding this, results in 10 threads, for a data set of 10 elements. So, if the data set is very large and is not distributed well, the number of threads might be too high and in certain cases might approximately equal the number of elements in the data set. Also, due to operating system and system resource constraints, there may be a limitation on the number of threads a process can create for parallelism of activities. Therefore, if the data set N is too large compared to the limit specified by a run time environment T_{RE}, one example considers T_{RE} directly as the number of threads.

Reallocating tasks as in block 108 is shown in greater detail in FIG. 4. In this example, each time any deviation in task completion is encountered, that is, if a task completes early, or if an allocated task does not complete in its predicted time, the tasks are reallocated among threads that are not stalled/delayed. Block 108 comprises in one example identifying a deviation in task completion in a thread in block 402, and allocating all non-started tasks to all threads that do not have deviations other than an early completion in block 404. That is, block 404 reallocates not yet run (started or completed) tasks to those threads that are not stalled/delayed. If a thread has a task that completes early, that can also be identified as a deviation, but in that situation, the deviation allows for reallocation to include that thread. If the thread has a task that has not completed in its predicted completion time that thread is excluded in the reallocation of non-started tasks. In one embodiment, a non-completion deviation from the predicted completion time is detected by the immediate next thread.

The allocation of block 404 is in one example accomplished according to the processes of FIGS. 1 and 2, ignoring the thread with the deviation when the deviation is a non-completed/stalled thread, but including the thread with the deviation when the deviation is an early completion in the thread. Reallocation is done in one example at every detected deviation.

For the example data shown in Table 1 above, the operation of the embodiments described in FIGS. 1-3 is shown below. In table 1, the predicted completion time is representative of a computed average connection time.

For the data of Table 1, the past connection time list can be represented as R[10]={100,50,30,420,320,200,70,228,328,8} with N=10, or as an ordered list R_{O}[10]={420,328,320,228,200,100,70,50,30,8}. In operation, the method of FIGS. 1 and 2 for allocating tasks to threads is shown in greater detail using the example data shown in Table 1 above. Using this example data, block 106 computes a number of threads by summing the connection times (block 302):
SUM=420+328+320+228+200+100+70+50+30+8=1754
   Dividing the sum by the largest predicted connection time (block 304) yields:
1754/420=4.17
   Rounding to the nearest integer (block 306) yields four as the number of threads.

Tasks are allocated to threads as follows. The ordered list R_{O}[10] (block 102) is used to assign tasks to the four threads T1, T2, T3, and T4 by assigning task R4 (predicted completion time 428) to thread T1, and the next three highest predicted completion time tasks R9, R5, and R8 to threads T2, T3, and T4, respectively, as shown in Table 2 (blocks 204 and 206).

TABLE 2

| Thread | T1 | T2 | T3 | T4 |
|---|---|---|---|---|
| | 420 | 328 | 320 | 228 |
| Total Allocated Time | 420 | 328 | 320 | 228 |

Once all threads T1-T4 have one allocated task, the tasks are assigned from that point forward, in descending order of expected completion time, to the thread having the lowest total predicted time of completion (blocks 208 and 210). For task R6 (predicted completion time 200), for example, thread T4 has the lowest total allocated time, and task R6 is assigned to thread T4:

| Thread | T1 | T2 | T3 | T4 |
|---|---|---|---|---|
| | 420 | 328 | 320 | 228 |
| | | | | 200 |
| Total Allocated Time | 420 | 328 | 320 | 428 |

For the sixth and seventh tasks R1 (predicted completion time 100) and R7 (predicted completion time 70), the tasks are allocates as follows:

| Thread | T1 | T2 | T3 | T4 |
|---|---|---|---|---|
| | 420 | 328 | 320 | 228 |
| | | | 100 | 200 |
| Total Allocated Time | 420 | 328 | 420 | 428 |

| Thread | T1 | T2 | T3 | T4 |
|---|---|---|---|---|
| | 420 | 328 | 320 | 228 |
| | | 70 | 100 | 200 |
| Total Allocated Time | 420 | 398 | 420 | 428 |

For the eighth task R2 (predicted completion time 50), thread T2 has the lowest total allocated time, so task R2 is assigned to thread T2:

| Thread | T1 | T2 | T3 | T4 |
|---|---|---|---|---|
| | 420 | 328 | 320 | 228 |
| | | 70 | 100 | 200 |
| | | 50 | | |
| Total Allocated Time | 420 | 448 | 420 | 428 |

For the ninth and tenth tasks R3 and R10:

| Thread | T1 | T2 | T3 | T4 |
|---|---|---|---|---|
| | 420 | 328 | 320 | 228 |
| | 30 | 70 | 100 | 200 |
| | | 50 | | |
| Total Allocated Time | 450 | 448 | 420 | 428 |

| Thread | T1 | T2 | T3 | T4 |
|---|---|---|---|---|
| | 420 | 328 | 320 | 228 |
| | 30 | 70 | 100 | 200 |
| | | 50 | 8 | |
| Total Allocated Time | 450 | 448 | 428 | 428 |

Following completion of task allocation among the threads T1-T4, the threads begin operation with their lowest predicted connection time task, and work toward the highest predicted connection time task (for example, tasks 50, 70, and 328 in thread T2). Applying this procedure results in a gradual increase in the total number of connections with time. For the above sample data and thread allocation, thread T1 runs for 450 ms, thread T2 for 448 ms, thread T3 for 428 ms, and thread T4 for 428 ms. Computing a standard deviation and average thread run time results in a standard deviation of 12.15181742, and an average thread run time of 438.5 ms. It should be understood that the same process can be applied when the tasks or system have constraints like a fixed number of threads or a maximum allowed response time before time-out.

In operation, the process of block 108, that is reallocating threads, is shown in greater detail using the example data shown in Table 1 above. With the example data of Table 1 and tasks allocated among four threads as shown, presume thread T3 did not finish its assigned task R10 (predicted completion time 8) on time and is continuing to attempt completion. At 30 ms, thread T1, after completing R3, observes that thread T3 has not yet finished and is still continuing with task R10 (block 402). So it invokes reallocation for thread balancing (block 404). In the following tables, bold text identifies running tasks, italicized text identifies completed tasks, and regular text identifies not yet started tasks.

| Thread | T1 | T2 | T3 | T4 |
|---|---|---|---|---|
| | 420 | 328 | 320 | 228 |
| | 30 | 70 | 100 | 200 |
| | | 50 | 8 | |
| Total Time Spent so far | 30 | 30 | 30 | 30 |
| Total Allocated Time | 450 | 448 | 428 | 428 |

Thread T3 is blocked with the task R10 which is still running, so the tasks R5 and R1 in thread T3, as well as tasks R9 and R7 on thread T2, task R4 on thread T1, and task R8 on thread T4, are rescheduled on other threads (block 108). Assuming thread T3 is suspended until it completes or times out with the task job R10, reallocation is accomplished considering the time already spent and the time expected to be used to complete the currently running tasks (R2 in thread T2, and R6 in thread T4, as they have already begun working) by other active threads, results in reallocation of tasks R4, R9, R5, R8, and R7, as shown below:

in preparation of rescheduling:

| Thread | T1 | T2 | T3 | T4 |
|---|---|---|---|---|
| | 30 | | | 200 |
| | | 50 | 8 | |
| Total Time Spent so far | 30 | 30 | 30 | 30 |
| Total Allocated Time | 30 | 50 | | 200 |

scheduling R4:

| Thread | T1 | T2 | T3 | T4 |
|---|---|---|---|---|
| | 420 | | | |
| | 30 | | | 200 |
| | | 50 | 8 | |
| Total Time Spent so far | 30 | 30 | 30 | 30 |
| Total Allocated Time | 450 | 50 | | 200 |

scheduling R9:

| Thread | T1 | T2 | T3 | T4 |
|---|---|---|---|---|
| | 420 | 328 | | |
| | 30 | | | 200 |
| | | 50 | 8 | |
| Total Time Spent so far | 30 | 30 | 30 | 30 |
| Total Allocated Time | 450 | 378 | | 200 |

scheduling R5:

| Thread | T1 | T2 | T3 | T4 |
|---|---|---|---|---|
| | 420 | 328 | | 320 |
| | 30 | | | 200 |
| | | 50 | 8 | |
| Total Time Spent so far | 30 | 30 | 30 | 30 |
| Total Allocated Time | 450 | 378 | | 520 |

scheduling R8:

| Thread | T1 | T2 | T3 | T4 |
|---|---|---|---|---|
| | 420 | 328 | | 320 |
| | 30 | 228 | | 200 |
| | | 50 | 8 | |
| Total Time Spent so far | 30 | 30 | 30 | 30 |
| Total Allocated Time | 450 | 606 | | 520 |

scheduling R1.

| Thread | T1 | T2 | T3 | T4 |
|---|---|---|---|---|
| | 420 | 328 | | 320 |
| | 30 | 228 | | 200 |
| | 100 | 50 | 8 | |
| Total Time Spent so far | 30 | 30 | 30 | 30 |
| Total Allocated Time | 550 | 606 | | 520 |

scheduling R7.

| Thread | T1 | T2 | T3 | T4 |
|---|---|---|---|---|
| | 420 | 328 | | 320 |
| | 30 | 228 | | 200 |
| | 100 | 50 | 8 | 70 |
| Total Time Spent so far | 30 | 30 | 30 | 30 |
| Total Allocated Time | 550 | 606 | | 590 |

After reallocation, thread T1 has a predicted total completion time of 550 ms, thread T2 has a predicted total completion time of 606 ms, and thread T4 has a predicted total completion time of 590 ms. If another deviation is detected, or if thread T3 completes, reallocation can be redone.

This disclosed method, when compared with the prior art Shortest Job First (SJF) principle, applied on the above ordered set of tasks R_{O}[10]={420,328,320,228,200,100,70,50,30,8} with 4 threads, results in the following task distribution:

| Thread | T1 | T2 | T3 | T4 |
|---|---|---|---|---|
| | 8 | 30 | 50 | 70 |
| | 100 | 200 | 228 | 320 |
| | 328 | 420 | | |
| Total Time Spent so far | 436 | 650 | 278 | 390 |
| Total Allocated Time | 436 | 650 | 278 | 390 |

A standard deviation of total run time between threads is 155.83 in this example, compared to a deviation of 12.15 using the embodiments described herein.

This disclosed method, when compared with the prior art Fastest-job-first principle, has an initial task scheduling results in the same task distribution, and deviation of 12.15 for an initial thread run:

| Thread | T1 | T2 | T3 | T4 |
|---|---|---|---|---|
| | 420 | 328 | 320 | 228 |
| | 30 | 70 | 100 | 200 |
| | | 50 | 8 | |
| Total Allocated Time | 450 | 448 | 428 | 428 |

However, differences lie in the order of scheduling the tasks, and rescheduling of tasks when an actual run time is different than predicted. After task allocation to the threads T1-T4, individual threads start working on tasks from lowest to highest predicted connection time. This results in a gradual increase in the total number of connections with time. Also, the present disclosed examples address detection and dynamic adaptation to deviations between actual and initial predicted task completion times.

The examples described herein have a limitation that if all the threads start servicing a job which runs indefinitely, all the threads will be busy. However, this situation can happen in any scheduling system, and can be overcome using a configurable maximum run time value, beyond which task could be suspended. For example, a time out of 5 minutes could be used when connecting to resources.

Further, effectiveness of the various methods described herein depends on correctness of the actual and predicted task completion values. If there are too many deviations between predicted and actual completion times, many in redistributions of tasks among the threads may occur. In a situation with a large number of deviations, one example uses a dedicated manager thread to check the health and monitor worker threads.

Various examples of the present disclosure may be embodied in a computer program product, which may include computer readable program code embodied thereon, the code executable to implement a method of balancing threads and allocating tasks to threads such as the methods described herein. The computer readable program code may take the form of machine-readable instructions. These machine-readable instructions may be stored in a memory, such as a computer-usable medium, and may be in the form of software, firmware, hardware, or a combination thereof. The machine-readable instructions configure a computer to perform various methods of thread balancing and allocation, such as described herein in conjunction with various embodiments of the disclosure.

In a hardware solution, the computer-readable instructions are hard coded as part of a processor, e.g., an application-specific integrated circuit (ASIC) chip. In a machine-readable instruction solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are machine-readable instruction solutions provided to the user on some form of removable computer-usable media or storage, such as a compact disc read-only memory (CD-ROM) or digital video disc (DVD). Alternatively, such computer applications may be delivered electronically, such as via the Internet or the like.

It will be appreciated that embodiments of the present disclosure can be realized in the form of hardware, machine-readable instructions, or a combination of hardware and machine-readable instructions. Any such set of machine-readable instructions may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement embodiments of the present disclosure. Accordingly, embodiments provide a program comprising code for implementing a system or method and a machine readable storage storing such a program. Still further, embodiments of the present disclosure may be conveyed electronically via any medium such as a communication signal carried over a wired or wireless connection and embodiments suitably encompass the same.

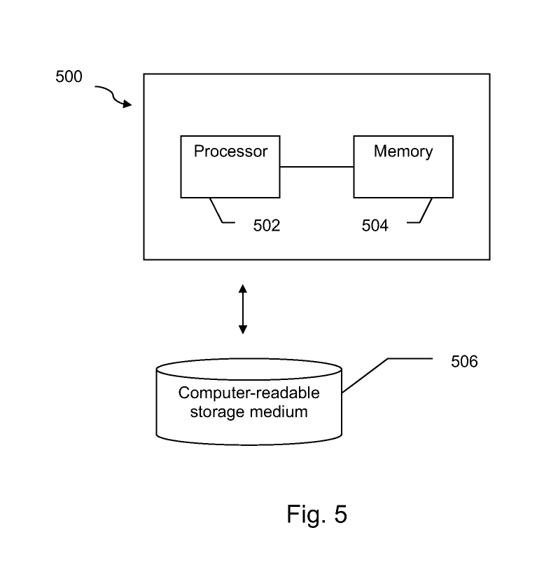

FIG. 5 is a representation of a computer system 500 for use with various embodiments of the disclosure. The computer system 500 includes a processor 502 connected to and capable of communication with a computer readable memory 504. Computer-readable storage medium 506 is in communication with system 500.

Computer-readable storage media in various embodiments may include different forms of memory or storage, including by way of example semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Further, the medium 506 may be located in any one of a number of locations, for example only, local to the system 500, or remotely located and accessible via a network such as a local area network (LAN), wide area network (WAN), storage area network (SAN), the internet, or the like.

Computer-readable storage media contains a computer program product having machine-readable instructions stored thereon adapted to cause the processor 502 to perform one or more methods of thread balancing and allocation described above with respect to FIGS. 1-4.

The features disclosed in this specification (including any accompanying claims, abstract and drawings), and/or the portions of any method or process so disclosed, may be combined in any combination, except combinations where at least some of such features and/or blocks are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The disclosure is not restricted to the details of any foregoing embodiments. The disclosure extends to any novel one, or any novel combination, of the features disclosed in this specification (including any accompanying claims, abstract and drawings), or to any novel one, or any novel combination, of the blocks of any method or process so disclosed. The claims should not be construed to cover merely the foregoing embodiments, but also any embodiments which fall within the scope of the claims.

Although specific embodiments have been illustrated and described herein, it is manifestly intended that the scope of the claimed subject matter not be limited to the specific embodiments, but only by the following claims and equivalents thereof.

What is claimed is:

1. A method for balancing thread creation and scheduling, comprising:
sorting a list of tasks according to a predicted completion time for each task;
assigning tasks to threads in order of total predicted completion time and into a thread specific queue;
causing a processor to execute the tasks assigned to the threads, starting in a reverse order of the thread specific queue; and
reallocating tasks to threads when a criteria is met.

2. The method of claim 1, and further comprising:
sorting the list from a longest to a shortest predicted completion time; and
assigning tasks to threads from the longest predicted completion time to the shortest predicted completion time.

3. The method of claim 1, and further comprising determining a number of threads to create, and wherein determining a number of threads to create further comprises:
computing a sum of the predicted completion time for all tasks; and
setting the number of threads as the nearest integer to the sum divided by the largest predicted completion time of all the tasks.

4. The method of claim 1, wherein assigning tasks to threads in order of total predicted completion time further comprises:
assigning the task with the highest predicted connection time to a first thread;
assigning the task with the next highest predicted connection time to the next thread until each thread has one assigned task; and
assigning the remaining tasks, from the task with the next highest predicted connection time to the task with the lowest predicted connection time, to the thread with a lowest total predicted connection time for all tasks assigned to the thread, until all tasks are assigned.

5. The method of claim 4, and further comprising:
after the completion of assigning the tasks to the plurality of threads, starting operation of each thread with its task having the lowest predicted connection time, and thereafter with its next lowest predicted connection time.

6. The method of claim 1, wherein assigning tasks to threads in order of total predicted completion time further comprises:
assigning the task with the highest predicted connection time to a first thread;
assigning the task with the next highest predicted connection time to the next thread until each thread has one assigned task; and
assigning the remaining tasks, from the task with the next highest predicted connection time to the task with the lowest predicted connection time, to the least loaded thread of the threads, until all tasks are assigned.

7. The method of claim 1, and further comprising:
identifying a deviation in completion time for a task in at least one thread;
reallocating all non-started tasks into all threads when the identified deviation is completion of the task before its predicted completion time; and
reallocating all non-started tasks into threads other than the at least one thread with an identified deviation when the identified deviation is delayed completion of the task.

8. The method of claim 1, wherein reallocating further comprises:
reallocating all non-started threads when a task is completed prior to its expected completion time.

9. The method of claim 8, wherein reallocating further comprises:
assigning each task in a thread which has a non-completed running task to a thread that does not have a running task.

10. The method of claim 9, wherein assigning each task further comprises:
ordering all remaining tasks that have not been started in threads that have non-completed tasks to free threads in order of expected finish time of current tasks.

11. A method of balancing thread allocation for a plurality of tasks on a plurality of threads, comprising:
assigning the task with a highest predicted connection time to a first thread of the plurality of threads, and repeating with the task with the next highest predicted connection time until each of the plurality of threads have one task assigned thereto;
assigning remaining tasks of the plurality of tasks to the plurality of threads in descending order of predicted completion time, wherein each remaining task is assigned to the least loaded thread of the plurality of threads based on a predicted total connection time for tasks assigned to the threads; and
scheduling execution of the tasks assigned to the threads by a processor.

12. The method of claim 11, and further comprising:
reallocating all non-started tasks among all threads when a task is completed early.

13. The method of claim 12, and further comprising:
when a task is delayed in completion time beyond its predicted completion time, reallocating all non-started tasks among all threads except the thread on which the task is delayed.

14. The method of claim 11, wherein reallocating further comprises:
reallocating all non-started tasks when a task on a thread is not completed in its predicted connection time, wherein reallocating is performed among all threads except the thread on which the task is not completed in its predicted connection time.

15. The method of claim 11, and further comprising:
monitoring for a deviation in task completion on the plurality of threads; and
reallocating tasks to threads when a deviation is detected.

16. A computer program product, comprising a computer usable medium having a computer readable program code embodied therein, the computer readable program code adapted to implement a method to balance task allocation among threads, and further adapted to:
sort a list of tasks according to a predicted completion time for each task; and
assign tasks to threads in order of total predicted completion time.

17. The computer program product of claim 16, wherein the computer readable code is further adapted to:
determine a number of threads to create by computing a sum of the predicted completion time for all tasks, and setting the number of threads as the nearest integer to the sum divided by the largest predicted completion time of all the tasks.

18. The computer program product of claim 16, wherein the computer readable code is further adapted to assign tasks to threads in order of total predicted completion time by assigning the task with the highest predicted connection time to a first thread, assigning the task with the next highest predicted connection time to the next thread until each thread has one assigned task, and assigning the remaining tasks, from the task with the next highest predicted connection time to the task with the lowest predicted connection time, to the thread with a lowest total predicted connection time for all tasks assigned to the thread, until all tasks are assigned.

19. The computer program product of claim 16, wherein the computer readable code is further adapted to assign tasks to threads in order of total predicted completion time by assigning the task with the highest predicted connection time to a first thread, assigning the task with the next highest predicted connection time to the next thread until each thread has one assigned task, and assigning the remaining tasks, from the task with the next highest predicted connection time to the task with the lowest predicted connection time, to the least loaded thread of the threads, until all tasks are assigned.

20. The computer program product of claim 16, wherein the computer readable code is further adapted to:
identify a deviation in completion time for a task in at least one thread;
reallocate all non-started tasks into all threads when the identified deviation is completion of the task before its predicted completion time; and
reallocate all non-started tasks into threads other than the at least one thread with an identified deviation when the identified deviation is delayed completion of the task.
